(19) United States
(12) Patent Application Publication
(10) Pub. No.: US 2014/0297617 A1
(43) Pub. Date: Oct. 2, 2014

(54) METHOD AND SYSTEM FOR SUPPORTING GEO-AUGMENTATION VIA VIRTUAL TAGGING

(71) Applicant: BROADCOM CORPORATION, Irvine, CA (US)

(72) Inventors: Yasantha Nirmal Rajakarunanayake, San Ramon, CA (US); William Stuart Bunch, Menlo Park, CA (US); Wael William Diab, San Francisco, CA (US)

(73) Assignee: BROADCOM CORPORATION, Irvine, CA (US)

(21) Appl. No.: 13/868,282

(22) Filed: Apr. 23, 2013

Related U.S. Application Data
(60) Provisional application No. 61/806,535, filed on Mar. 29, 2013.

(51) Int. Cl. G06F 17/30

(52) U.S. Cl. CPC G06F 17/30867; G06F 17/30241
USPC 707/709; 707/724

(57) ABSTRACT

A system and method provide for geo-augmentation through virtual tagging. A search infrastructure supports creation, managing and searching geo-coded virtual tags using mobile communication devices. Associated geolocations are added to a geolocation database along with pointers to the stored content. Searching of the geolocation database is performed upon receiving geolocation search input, wherein the infrastructure applies the geolocation based search input to the search database yielding search results delivered from the mobile communications device for presentation to the user.

### CROSS REFERENCE TO PRIORITY APPLICATIONS

### Incorporation by Reference

The present U.S. Utility patent application claims priority pursuant to 35 U.S.C. §119(e) to the following U.S. Provisional Patent Application Ser. No. 61/806,535, entitled “Method and System for Supporting Geo-Augmentation Via Virtual Tagging,” (Attorney Docket No. BP31923) filed Mar. 29, 2013, pending, which is hereby incorporated herein by reference in its entirety and made part of the present U.S. Utility patent application for all purposes.

### BACKGROUND

1. Technical Field

This technology described herein relates generally to internet searching infrastructures and more particularly to geo-based virtual tagging of content and searching thereof.

2. Description of Related Art

Today, a large amount of Internet searching is performed from a remote location using portable or hand-held mobile communication devices. These devices are often equipped with cameras and global positioning system (GPS) sensors providing the user with access to web-based information based on their physical proximity. In a process called geo-tagging, information such as photos, videos, websites, and other forms of media can be provided along with geospatial metadata. This data typically comprises latitude and longitude coordinates, however it is can also include altitude, bearing, distance, accuracy data as well as other location information. Recent technological improvements have enhanced the interaction between geo-tagged data and mobile communication devices. For example, collected user information, including current location, may be used to modify the search query and search results providing the user with proximity based results.

However, current approaches limit the amount of information available to display in the real-world environment. Conventional search infrastructures, such as Google® and Bing®, crawl Web hosting servers to gather Web page text and associated media content. Such gathered text and data are (i) preprocessed to extract search database content, and (ii) cached to support search results when a server is out of action (to cache a graphic image for their search engine). If a user desires to make any content available on the Internet, they must either establish a web server or upload their content to a web server based hosting service.

Disadvantages of conventional approaches will be evident to one skilled in the art when presented in the disclosure that follows.

### BRIEF DESCRIPTION OF THE DRAWING(S)

The technology described herein is directed to an apparatus and methods of operation that are further described in the following Brief Description of the Drawings and the Detailed Description. Other features and advantages will become apparent from the following detailed description made with reference to the accompanying drawings.

FIG. 1 is a screen shot illustrating one embodiment of the technology described herein;

FIG. 2 is a system diagram illustrating one embodiment of the technology described herein;

FIG. 3 is a flow diagram illustrating one embodiment of a geolocation virtual tag creation as per the technology described herein;

FIG. 4 is a search infrastructure diagram illustrating one embodiment of the technology described herein;

FIG. 5 illustrates a flow diagram generally showing one embodiment of receiving virtually tagged information based on location;

FIG. 6 illustrates a flow diagram showing one embodiment of the technology described herein of creating a geolocation virtual tag and providing the geolocation virtual tag to selected targets;

FIG. 7 illustrates a screen shot illustrating one embodiment of a geolocation virtual tag posting interface including selection of files;

FIG. 8 illustrates a screen shot illustrating one example embodiment of the technology described herein of a geolocation virtual tag posting;

FIG. 9 illustrates a flow diagram illustrating one example embodiment of searching a geolocation virtual tag posting;

FIG. 10 illustrates a flow diagram showing one embodiment of a geolocation virtual tag retrieval including setting of user preferences; and

FIG. 11 illustrates a screen shot illustrating one embodiment of a geolocation virtual tag search interface including user preference setting of timing.

### DETAILED DESCRIPTION OF THE INVENTION

In various embodiments of the technology described herein, a system and method is provided to support geo-augmentation via geolocation virtual tagging. In one embodiment, geo-augmentation by geolocation virtual tagging allows users, via hand-held devices (smartphones, cameras, tablets, etc.), to annotate various geolocations around the world. A geolocation virtual tag (virtual tag) might be, for example, a text note praising a current restaurant (posted while at such restaurant), a photo taken atop the Eiffel Tower at night, a Macy's parade video and text note, a text note on a hiking trail advertising a local café, an advertisement from a close proximity business, or the like. Each of such virtual tags, upon posting, receives an associated geolocation. In this way, virtual tags can annotate the world. With such annotations, a user at a particular geolocation can use their mobile communications device to access virtual tags in geo-proximity. Annotations are supplied to the system by users via posting uploads directly from the user's mobile communications device. A search infrastructure stores each virtual tag posting element along with an associated geolocation. The associated geolocations are added to a geolocation search database along with pointers to the stored content.

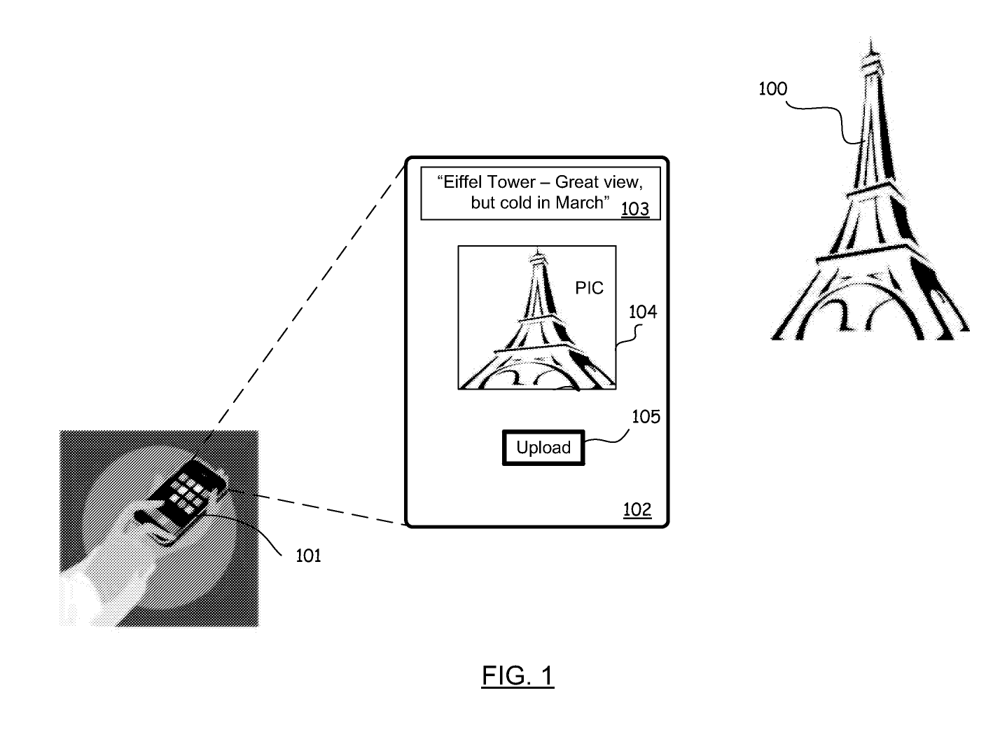

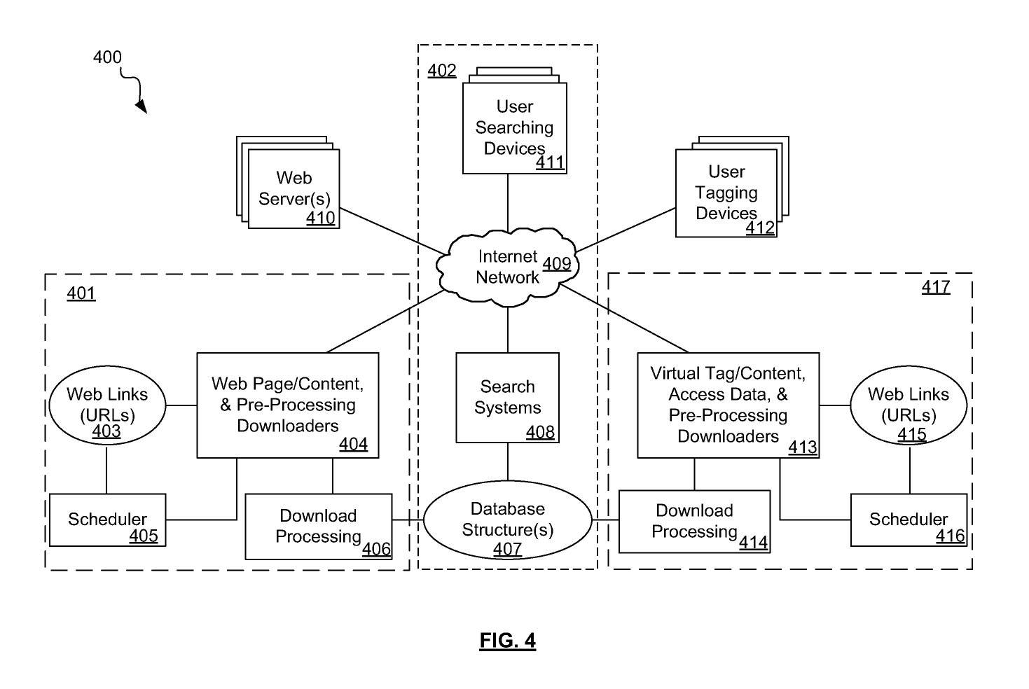

FIG. 1 illustrates one example embodiment of creation of a geolocation virtual tag for a person visiting the Eiffel Tower 100. As shown, a visitor with a mobile communications device 101 (e.g., smartphone), using the technology described herein, enters on user interface (UI) 102, text 103 describing what they think and see while visiting the Eiffel Tower. They can add a picture 104 taken by their smart phone camera. When they select upload, their text and picture will become part of a virtual tag. Also attached to the virtual tag will be their physical location (e.g., geocoordinates) at the time of tagging. The combined tag will be provided to a search system (see FIG. 4) for later access by location or search string as will be described in greater detail hereafter.

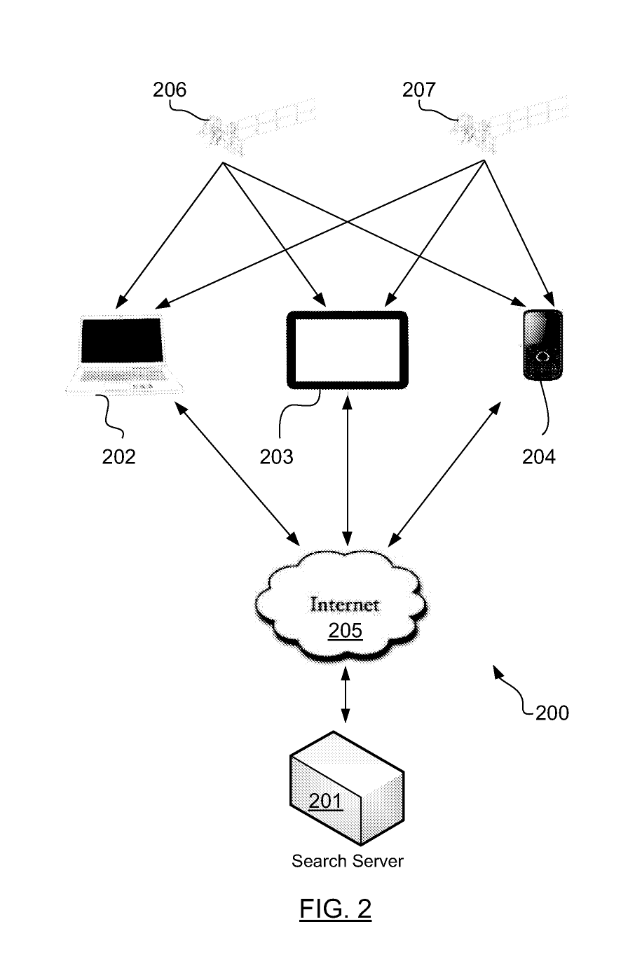

FIG. 2 is an exemplary system diagram illustrating a communications environment embodiment of the technology described herein. System 200 includes search system 201 connected to a plurality of mobile communication devices, for example, laptop 202, tablet 203 and smartphone 202, connected via network 205 and in geographically distinct locations. Network 205 may comprise any know or future communications network, structure or standard such as, but not limited to, 3G (Third Generation), 4G (Fourth Generation), LTE (Long-term Evolution), GSM (Global System for Mobile Communications), Wi-Fi, WiMax, WLAN (wireless area network), a WAN (wide area network), a LAN (local area network) and MIMO (Multiple Input Multiple Outputs). In various embodiments, the mobile communication devices are in communication with GPS satellites 206 and 207, and/or terrestrial based location providing services to provide the mobile communication devices with location information. In alternative embodiments, location information for the mobile communication devices is obtained using other information such as media access control (MAC) address, internet protocol (IP) address, or equivalents known or future.

In various embodiments, mobile communication devices 202 to 204 are a mobile phone such as a cellular telephone, a local area network device, personal area network device or other wireless network device, a personal digital assistant, personal computer, laptop computer, wearable computers, tablet computers or other devices that perform one or more functions that include communication of voice and/or data via a wireline connection and/or the wireless communication path. In other embodiments, mobile communication devices 202 to 204 are an access point, base station or other network access device that is coupled to network 205 such as the Internet or other wide area network, either public or private, via a wireline or wireless connection.

In alternative embodiments, location information for the mobile communication devices is obtained using other information such as media access control (MAC) address, internet protocol (IP) address, or the like.

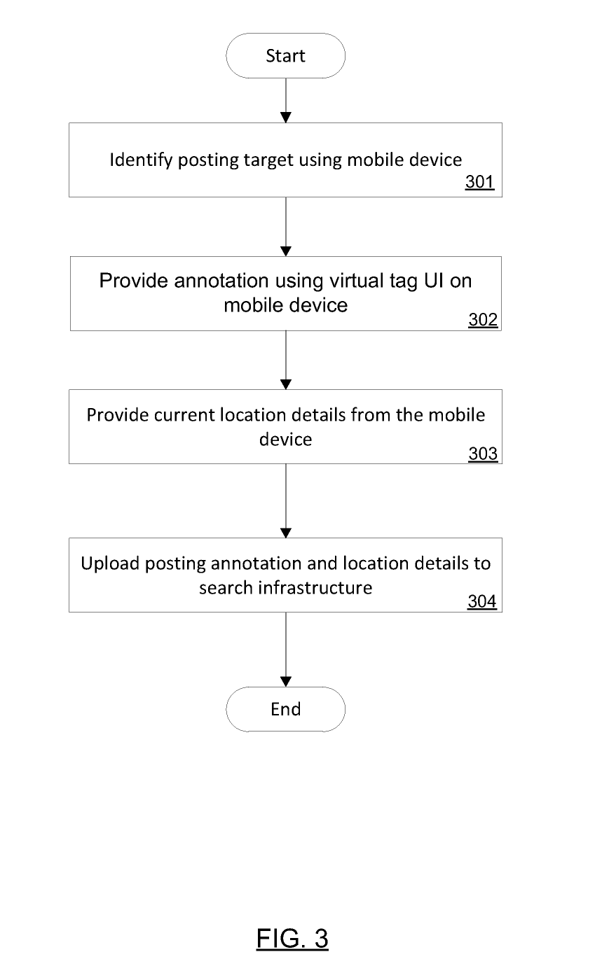

FIG. 3 illustrates a flow diagram showing one embodiment for geolocation based virtual tagging using the virtual tagging UI. In step 301, users identify a location with a virtual tagging UI displayed by a mobile communications device. After the location has been identified, the user provides annotation(s) for the geolocation virtual tag using the virtual tagging UI in step 302. The mobile communication device provides the location details of the virtually tagged element in step 303. Step 304 posts the location details and annotations of the geolocation virtual tag to the search infrastructure (FIG. 4).

In various embodiments, the virtual tagging UI is integrated into the mobile communication device, an accessory of the mobile communication device or a third party application capable for functioning on the mobile communication device.

FIG. 4 illustrates one example embodiment of a system to support one or more elements of the technology described herein. System 400 includes web crawler 401 and search infrastructure 402. Web crawler 401 systematically browses the World Wide Web, typically for the purpose of building a database of web based content. Web crawler 401 uses a list of web links 403 such as uniform resource locators (URLs) to visit. The URLs are called seeds as they start a process of content discovery and typically are provided by domain registrations. As the crawler visits these URLs, one or more web page downloader(s) 404 parse the URLs to identify unique hyperlinks in the page which point to web server 410 stored content. URLs are typically recursively visited according to a set of policies which detect structure and content. As links are traversed, web pages and specific content are downloaded by downloader(s) 404 as per a schedule dictated by scheduler 405.

Web page downloader(s) 404, in one embodiment, further include preprocessing of webpages. Preprocessing, typically performed by web server(s) 410, includes extracting, in one embodiment, non-text information about images. For example, information about the image can be passed directly to the database structures 407 without needing the download processing 406. This information includes, for example, whether the image is black and white, a sketch, drawing file, full color, a photograph, clip art, facial recognition, age/sex id (i.e., adult, child, senior, male, female, etc.). In addition, in one embodiment, access information is extracted such as public, private, sharing lists, grouping, download and distribution rights, security, or access based on income, gender, age, location, citizenship, relationships, membership, etc.

Download processor 406 reverse indexes a selected web page to encode web page words (e.g., frequency) and note location on the associated page (offset) so that content can be recovered (extracted) at a later time. The indexed data is transferred to a search engine database structure 407 where it is stored for later access by search systems 408. Search systems 408 receive Hypertext Transfer Protocol (HTTP) sequences to parse/hash database structures 407 to retrieve, for example, data, text, images, video, software, code, etc. HTTP is an application protocol for distributed, collaborative, hypermedia information systems.

Database structures 407 typically include indexes of unique words with associated index pointers (URLs) and web page position information. Unique words are hashed using a hash table. A hash table (also hash map) is a data structure used to implement an associative array, a structure that can map keys to values. A hash table uses a hash function to compute an index into an array of buckets or slots, from which the correct value can be found. Unique words are typically arranged by frequency (e.g., highest to lowest) and also carry importance using frequency ranking. For example, in the phrase “the cat”, the word “the” is not important and the word “cat” is important. Rare words are often given highest importance along with strings of words and rare strings of words.

Internet Network 409 is a global system of interconnected computer networks that use the standard Internet protocol suite (TCP/IP) to serve billions of users worldwide. It is a network of networks that consists of millions of private, public, academic, business, and government networks, of local to global scope, that are linked by a broad array of electronic, wireless and optical networking technologies. The Internet carries an extensive range of information resources and services, such as the inter-linked hypertext documents of the World Wide Web (WWW) and the infrastructure to support email. The internet network is used to interconnect the various elements of system 200 and is implemented using known and future communication infrastructures such as wireless and wired networks including, but not limited to, wireless local area networks (WLANs), wide area networks (WANs), local area networks (LANs), Ethernet, fiber optic or other known or future communication network infrastructures. Internet Network 409 interconnects web servers 410 which store the various web pages and associated content to Web crawler 401 to the search systems 408 which use the indexed data to match a user input search string from a user searching device 411 (e.g., smartphone, tablet, laptop, desktop or other known or future user devices with communications capabilities).

The system infrastructure is, in various embodiments described herein, also in communication with one or more GPS satellites and/or terrestrial geographic location systems (FIG. 2 elements 206 and 207) that provide the one or more communication devices with location information. In alternative embodiments, location information for one or more communication device is obtained using other information such as media access control (MAC) address, an internet protocol (IP) address, or the like.

In various embodiments of the technology described herein, system 400 includes searching of geolocation virtual tags. Geolocation virtual tagging includes virtual tag creation by user tagging devices 412 as will be described in greater detail hereafter. Once created, the geolocation virtual tags are stored locally (e.g., on the user tagging device 412 with an associated pointer to the tag) or remotely (e.g., using the search infrastructure and/or in the cloud including third party servers with a pointer (e.g., hyperlink or URL) to the tag).

Virtual tagging crawling system 413 mirrors Web crawling elements 401. Virtual tagging crawling system 413 accesses and parses stored geolocation virtual tags in much the same way a traditional web crawler would crawl a web page. The virtual tagging crawling system 417 includes, but is not limited to, one or more geolocation virtual tag downloader(s) 414 which access, parse and process the virtual tags in a similar fashion to web pages for web page downloader 404. Geolocation virtual tag downloader(s) 414 include downloading of the virtual tag including associated content, access data and, in one aspect embodiment, preprocessing of content. Pointers 415 are provided to the geolocation virtual tag downloader(s) 414. Pointers include uniform resource locators (URLs) or global network routes (GNRs) which are unique routes that will guide a future search request to the virtual tag or specific portions of the virtual tag. The virtual tagging crawling system 413 further includes scheduler 416 to schedule the crawling of the geolocation virtual tags and download processor 417 to reverse index and distribute to database structures 407.

The technology described herein provides users with the ability to create geolocation virtual tags for various objects throughout the world. In further embodiments, a system infrastructure 400, as shown and described in FIG. 4, provides an infrastructure which stores each virtual tag posting element along with its associated geolocation. In an alternative embodiment, one or more portions (e.g., device ID, type, access restrictions, update modes, status, etc.) of the virtual tags are stored in a virtual tag registry (not shown) accessible by the search infrastructure. In yet another aspect embodiment, one or more portions of virtual tags are temporarily cached.

Upon receiving a geolocation search input (e.g., a GPS location of a first mobile communications device), the infrastructure applies the geolocation input to the search database, yielding a search result including those geolocation virtual tags having a geolocation in proximity to the geolocation search input. Such identified geolocation virtual tags can then be delivered from storage to the user searching devices 411 (e.g., search request from mobile device) for presentation to the user. It is to be understood that the search infrastructure is, in one embodiment, created or provided by an independent entity such as an independent service, or integrated into conventional Web search infrastructures.

The virtual tagging system as described in FIG. 4 includes various elements described hereafter which can create, store, edit, manage, distribute and receive virtual tags associated with a geocoded (location tagged) data element (e.g., image, review, business, etc.). Virtual tagging includes, in one embodiment, adding annotations to geocoded objects (e.g., leaving a review of a visited tourist spot like the Eiffel Tower). Tagging is performed with a user tagging device. Using an example smartphone, a user takes a picture, includes a notation about their experience, has the picture and notation geocoded to capture a user device position and uploads their just created virtual tag using the internet to be eventually indexed, stored and managed. Virtual tag data includes, in various embodiments, pictures, text, video, documents, profile information, personal information, public information, opinion, news, etc. Virtual tag data includes, for example, pictures of buildings or other objects of interest (e.g., family members, vacation spots, sporting events), posts such as social media, texts, tweets, journal-based entries, timelines, advertising, etc.

In addition to the location and data content, virtual tag data includes, in various embodiments of the technology disclosed herein, adding access restrictions. Restrictions include, but are not limited to, audience based restrictions such as limited access by a specific person, my family, social circles, aged based such as adults only or kids only, social groups, membership based, security based (e.g., must have password), distribution restrictions, time based (e.g., limited time only, time period, specific time of day, next few minutes, week, month, year, seasonable, etc.), number of accesses (e.g., can only view virtual tag 3 times, 3 times in a specified time frame (e.g., per day), location based, etc.).

Additional examples of access restrictions include, but are not limited to: payment for the geolocation virtual tag or associated service or product (e.g., coupon or discount when purchasing a geolocation virtual tag listed item (e.g., coffee from a menu or advertisement)); default access settings for the tagger (creator of geolocation virtual tag); a standard list of access limitations; a multi-tier access system (one access restriction at one level and another at the next level); classes of service; and templates with associated access restrictions.

Virtual tags, in various embodiments of the technology disclosed herein, include communication based options. For example, a tagger (geolocation virtual tag creator) includes a provision in the geolocation virtual tag to initiate a communication session directly with the viewer of the geolocation virtual tag (e.g., to order from a menu, select and purchase from a list of sale items, make a reservation, etc.). The communication session includes, but is not limited to, a chat frame, video conference, email, text, tweet, order template, or telephonic communication (e.g., voice call, voice over IP (VOIP) call, or downloaded audio message, etc.)

User tagging devices 412 include, but are not limited to: mobile phones; smartphones; tablets; laptops; desktops; or other known or future user computing devices with communications capabilities. In one or more embodiments disclosed herein, mobile communication devices are the recipients of geolocation virtual tags. These mobile communication devices are, in various embodiments, a mobile phone such as a cellular telephone, smartphone, a local area network device, a personal area network device or other wireless network device, a personal digital assistant, a personal computer, a laptop computer, wearable computers (e.g., heads-up display (HUD) glasses), tablet computers or other devices that perform one or more functions that include communication of voice and/or data via a wireline connection and/or the wireless communication path. Additionally, in various embodiments, mobile communication devices are an access point, base station or other network access device that is coupled to a network such as the Internet or other wide area network, either public or private, via a wireline/wireless connection.

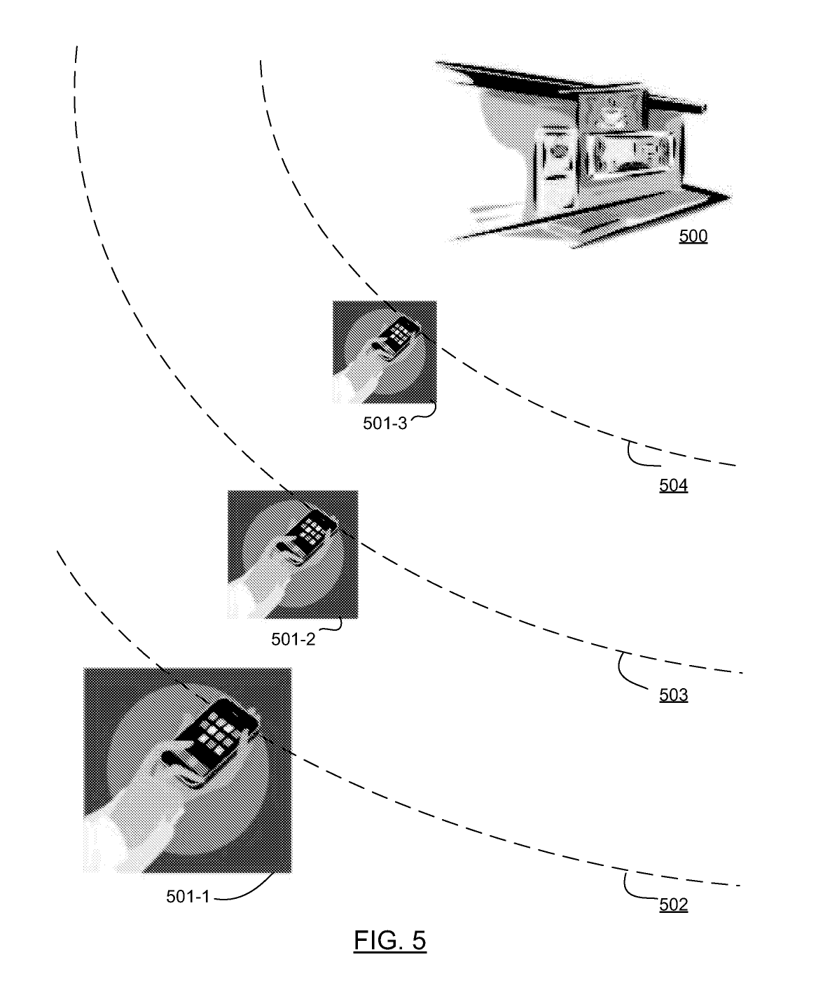

FIG. 5 illustrates one embodiment of a system implementing geolocation virtual tags. As shown, a business (e.g., coffee shop) 500 wants to attract customers. The business (tagger) creates a geolocation virtual tag with a product offer using a computing device with communications capabilities which is either hosted locally or remotely and is connected to the search system as shown in FIG. 4. A user 501-1 with a mobile communications device, for example a smartphone, approaches business 500 at a radial distance 502 (e.g., 1600 ft.). The created geolocation virtual tag is either pushed or pulled (e.g., by searching) to the user at this distance if the geolocation virtual tag has a selected coverage area in this range. If the created geolocation virtual tag has a smaller radial distance coverage area (e.g., 800 ft.), user 501-2 receives the virtual tag at range 503. If the radial range is even smaller (e.g., 400 ft.), the virtual tag is received by user 501-3 at range 504. Users 501-1, 501-2, and 501-3 are, in various embodiments, the same customer as they approach business 500, different users or a combination thereof. For illustration purposes, the system is shown with three users, but the technology is not limited to a specific number of users.

The large amount of virtual tags will result in a great number of virtual tags and a user is likely to encounter high volume areas by moving into proximity thereof. Coming into proximity of a highly posted location could result in posted virtual tags having no interest to the users. As a result, embodiments of the technology described herein comprise the necessary searching infrastructure to filter, refine or modify the results included in the virtual tags.

A further embodiment allows the user to define ranging parameters based on particular user types and user behaviors. For example, if a user just visited a coffee shop for an hour, they can define ranges so that the system will not show postings concerning coffee hours for an explicit period of time (i.e., 6 hours). It is understood that alternative modes of operation are available to both the poster and to the viewer.

In another aspect embodiment, a mobile communication device user can enhance the search input beyond that of merely geo-location based information. Users can enhance the search infrastructure by adding support for various types of search annotations including text, video, image, audio, code, etc. Thus, a roaming user might pull up the virtual tag user interface (UI) and find 10,000+ virtual tag postings at a popular street corner or location. Instead of attempting to sift through everything, the user provides search input by (i) taking a photo of a location (i.e., Starbucks Coffee Shop), and (ii) typing in “review.” Such search input along with the user's geo-location, enables the search infrastructure to identify a small subset of the original 10,000+ postings. In certain embodiments, the user can sort the results by date, alphabetical order, type, and/or a combination thereof.

To improve applicability of virtual tagging, both search restriction setups and background searching with user alerts are, in various embodiments, included. For example, via a browser interface, a user might interact to define a series of searches (search input plus filter tool settings) of interest relating to coffee shops, computer stores, job opening postings, etc. All or any of the filters could be set to run in the background with a specified (i.e., time and/or distance) or standard periodicity. Thus, as the user roams, such filters are each supplemented with current geo-location data (from the user via the user's hand-held device) and sent to the search infrastructure to fine proximate and relevant virtual tags. Once found, user alerts are used to draw the user's attention. Alerts are used for when a user is possibly engaged with other applications or has the mobile communications device in pocket, the background searching can continue in background and only alert if virtual tags become available. User alerts may include visual, audible, tactile (e.g., vibrations) or a combination thereof.

In one or more embodiments disclosed herein, mobile communication devices are the recipients of virtual tags. These mobile communication devices are, in various embodiments, a mobile phone such as a cellular telephone, a local area network device, a personal area network device or other wireless network device, a personal digital assistant, a personal computer, a laptop computer, wearable computers (e.g., heads-up display (HUD) glasses), tablet computers or other devices that perform one or more functions that include communication of voice and/or data via a wireline connection and/or the wireless communication path. Additionally, in various embodiments, mobile communication devices are an access point, base station or other network access device that is coupled to a network such as the Internet or other wide area network, either public or private, via a wireline/wireless connection.

The technology described herein includes a geolocation virtual tagging posting user interface (UI) provided on the mobile communications device. The geolocation virtual tagging posting UI allows the user of the mobile communications device to physically identify a location as well as the posting target. For example, the mobile communications device user is in physical proximity to the Washington Monument and wants to post a photo of the monument along with a text annotation. The UI allows the user to take a photo using the camera provided by the mobile communications device and input the annotation.

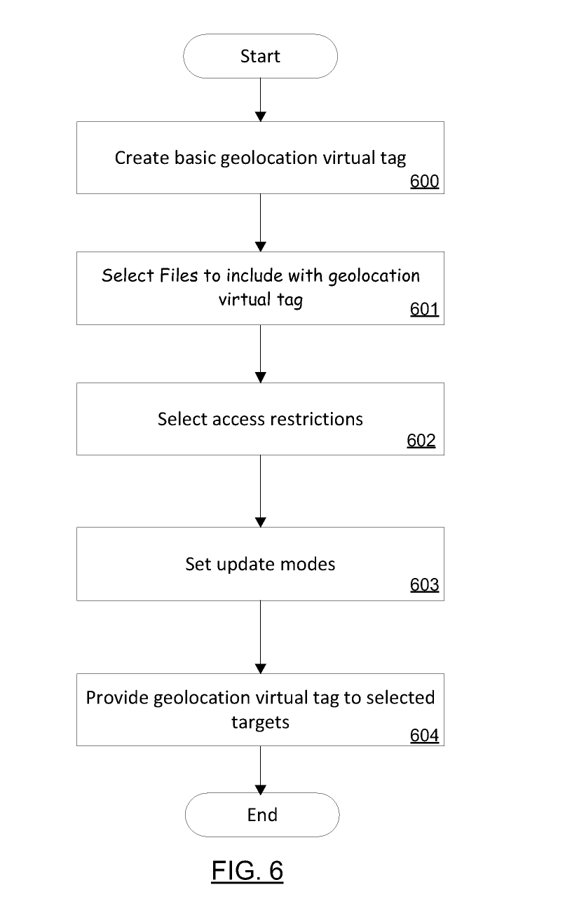

FIG. 6 illustrates a general flow diagram showing one embodiment for creation (posting) of a geolocation virtual tag as per the technology described herein. In step 600, a basic geolocation virtual tag is created by a tagger (e.g., a business). A basic geolocation virtual tag includes at least the geolocation associated with the virtual tag and one or more annotations as shown in FIG. 1 and FIG. 3. In addition to the basic geolocation virtual tag, in various embodiments, the basic geolocation virtual tag is augmented to include additional data. In step 601, additional information, such as files, are added (attached) to the basic geolocation virtual tag being created. In various embodiments, the files include, but are not limited to: maps; directions; menus; specials; advertising; reviews; order templates; etc. In step 602, access restrictions are added to the geolocation virtual tag. Access restrictions include, but are not limited to: access to specific targets (customers); access based security; scheduling; and payment options. In step 603, update modes are added to the geolocation virtual tag. Update modes include whether to push or pull the geolocation virtual tag. In push mode, the geolocation virtual tag is transmitted (e.g., wirelessly) and in pull mode, the target customer comes across the virtual tag using a search function. In addition, in various embodiments, the update modes include, but are not limited to: coverage (e.g., distance away, radius, geographic zone, etc.); number of tags to dispense; management; motion vector characteristics; and trigger information. And finally, in step 604, the completed geolocation virtual tag is provided to selected targets (i.e., potential users of the tag (e.g., customers)) by pushing/pulling it over communication networks (e.g., wireless).

In another aspect embodiment, the process of creating virtual tags includes an authentication process 605 to ensure that tagging devices are at (or in proximity) to the geolocations represented by the virtual tag. In one aspect embodiment, each step of the virtual tag process is authenticated to create a secure virtual tag with a virtual tag auditable trail. This audit trail can be used to detect fraud, a timeline of events (crime witnesses created virtual tags), etc.

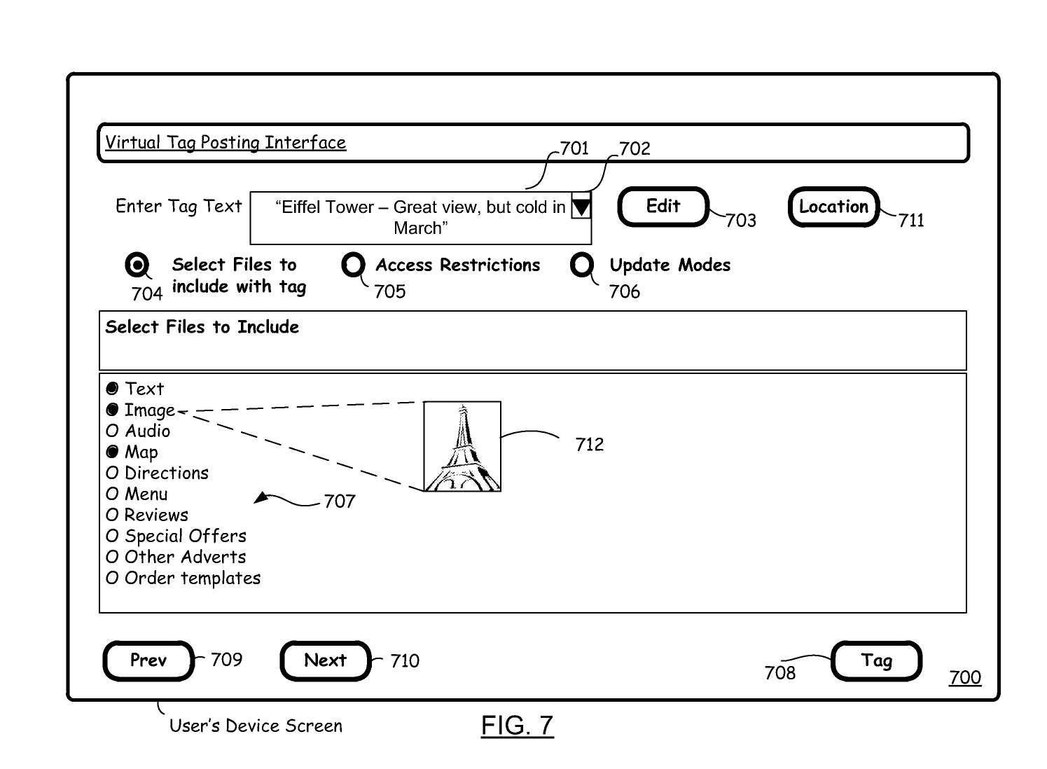

FIG. 7 illustrates various embodiments of creating geolocation virtual tags using a geolocation virtual tag posting interface. A shown, FIG. 7 illustrates a user interface (UI) with geolocation virtual tag posting (shown as a pop-up screen shot on a user's device) 700 for a geolocation virtual tag poster (seller, friend, etc.). Included are fields for typing in geolocation virtual tag text 701 or alternately selecting 702 and editing text 703 from a list of previously made geolocation virtual tags (including those made by the tagger, a third party and/or template tags). While shown for entering text, other forms of media are considered within the scope of the technology described herein, such as images, video, audio, music, etc. A basic geolocation virtual tag will automatically include the text and geolocation (location 711) associated with the virtual tag. In various embodiments, a user selects location button 711 which automatically attaches the location of the user's device (using known techniques, such as the device's GPS, coordinates, look-up address or equivalent known or future techniques) or provides the user with a text box to input their location or select their location from either a list or map.

In addition, in one embodiment, it is possible to add one or more files to the geolocation virtual tag during creation 704. In various embodiments, the files 707 include, but are not limited to: text, images (e.g., pictures or video), audio (such as music or attention getting sounds like ring tones), maps, directions, menus, reviews, special offers, advertising, order templates, purchase templates, etc. The technology described herein is not limited by a specific file or file type. It is envisioned that differing file types and associated content are equally within the scope of the technology described herein. Other UI selections include access restrictions 705 and update modes 706 which are described herein in greater detail hereafter. Selections next 709 and previous 710 enable traversing a list of sequential or related geolocation virtual tags.

Specific access restrictions 705 include, but are not limited to: one or more specific users/user-devices; identity (ID); group characteristics; password/security requirements; advertising logic selections (including attract mode behaviors); sales interfacing selections/behaviors; purchase support selections; handover selections; anonymity settings; post scheduling and duration; payment options for: associated advertising (incoming revenue), click through or sales completion fee collections/services (outgoing revenue); hosting/caching, etc.; operational modes including client hosted without caching and only pre-processing uploads, client hosted with no pre-processing, shared hosting, search system hosted.

Specific update modes 706 include, but are not limited to: push (e.g., transmitting wirelessly), pull (search retrieves geolocation virtual tag in search results) or periodic pull (user device periodically pulls available geolocation virtual tags), and a mix of the two where push indication for need is followed up by a scheduler with a pull; numerical or mapping interface that allows a poster to define either a coverage radius or any other odd shaped coverage zone (e.g., with support based on historical data illustrating the likely performance of such ad on a minute to minute . . . year to year, etc., basis); auto shut-down/pause behaviors (e.g., dispense this number of geolocation virtual tags per day or total then stop (and possibly discard)); pending tag management system to turn off or add more geolocation virtual tags (or search the user's own geolocation virtual tags—including search results populating a map with tag type icons and performance/status information modifying the icon look and feel); motion vector characteristics; and triggers.

Please note that FIG. 7 represents, in various embodiments, possible posting selections. A basic geolocation virtual tag will typically comprise at least an annotation and location information. Additional virtual tag criteria selections, while not strictly required, provide a more sophisticated and possibly more effective geolocation virtual tag as the target audience is narrowed and/or focused. Any number of selections, restrictions and modes are envisioned within the scope of the technology described herein.

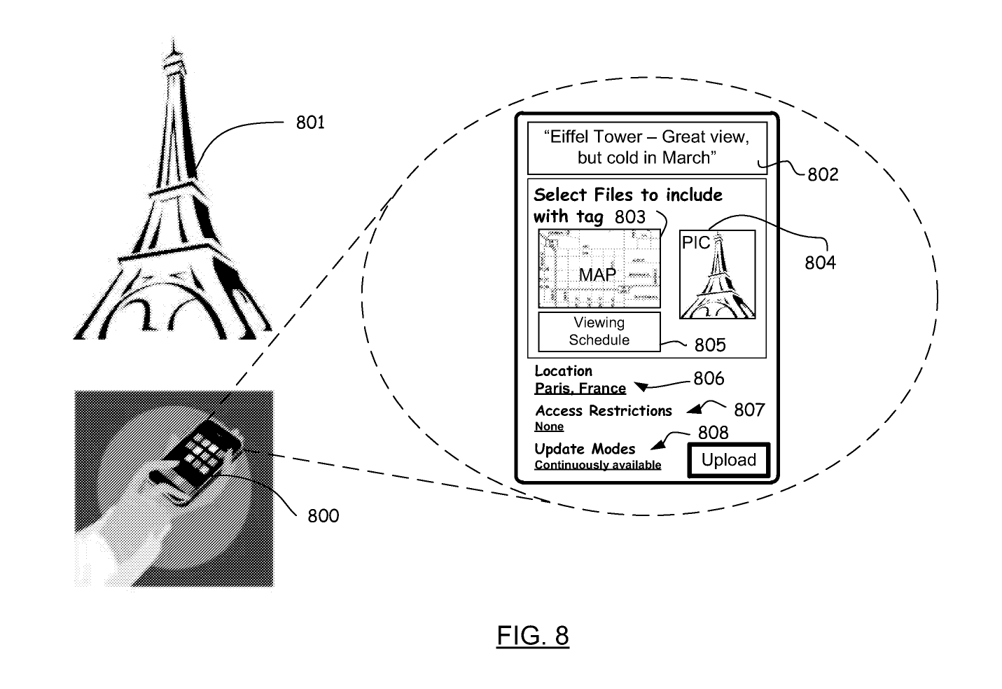

FIG. 8 illustrates an example embodiment screen shot for a virtual tag poster using the system and method of the technology described herein. As shown, a tagger (visitor) 800 enters text 802 of their experience of visiting the Eiffel Tower 801—“Eiffel Tower—great view but cold in March”. In this example, they add three files to the virtual tag. A first file is a map 803 of Paris. A second file includes picture 804 they took or downloaded with their mobile device of the Eiffel Tower. A third file comprises the viewing schedule 805. The created virtual tag includes the geolocation 806 (e.g., manually (address or selection from a map) or automatically by their built-in GPS) and then add applicable access restrictions 807 and applicable update modes 808.

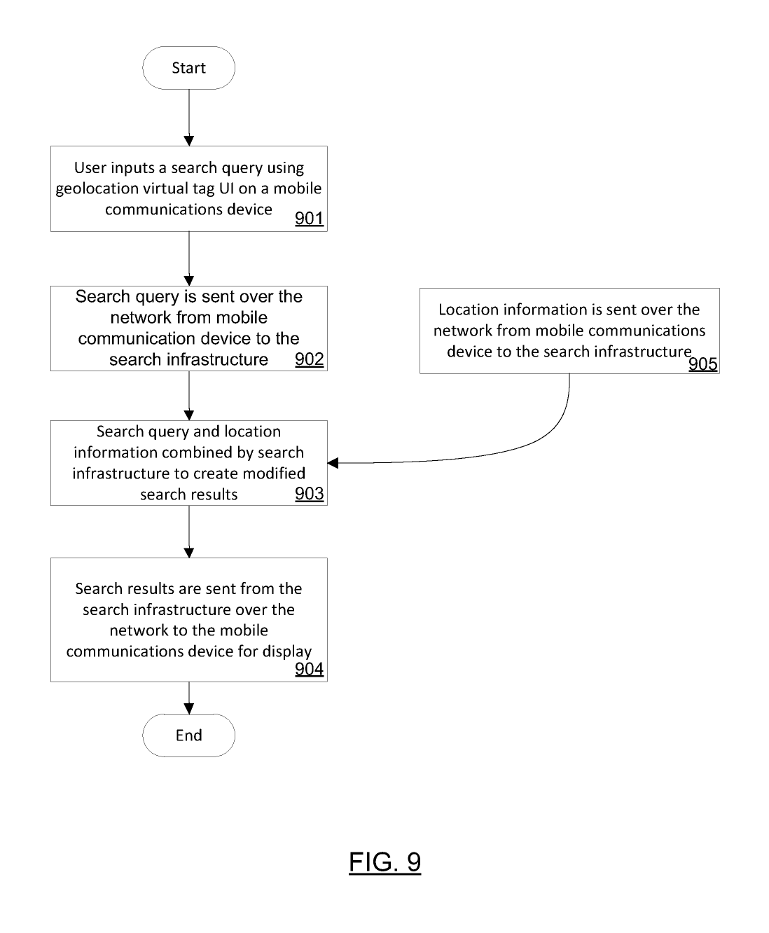

FIG. 9 illustrates a flow diagram showing one embodiment of searching using virtual tags. Process 900 begins at step 901 when a user inputs a search query into the virtual tag UI provided on the mobile communication device. Search inputs may include images, text, video, audio or a combination thereof. The search query is sent to the network from the mobile communication device in step 902. In conjunction with the search query input provided in step 902, step 905 provides the location information to the network via, for example, a mobile communications device. The location information is provided to the network by a message sent from the mobile communication device or other methods for communicating location information. In alternative embodiments, the location information of a first mobile communication device is provided by a second mobile communication device. The information from steps 902 and 905 is combined in step 903 and uploaded to the search system over the network for processing. In step 904, when a search is performed, the search results are returned to the requestor (e.g., mobile communications device).

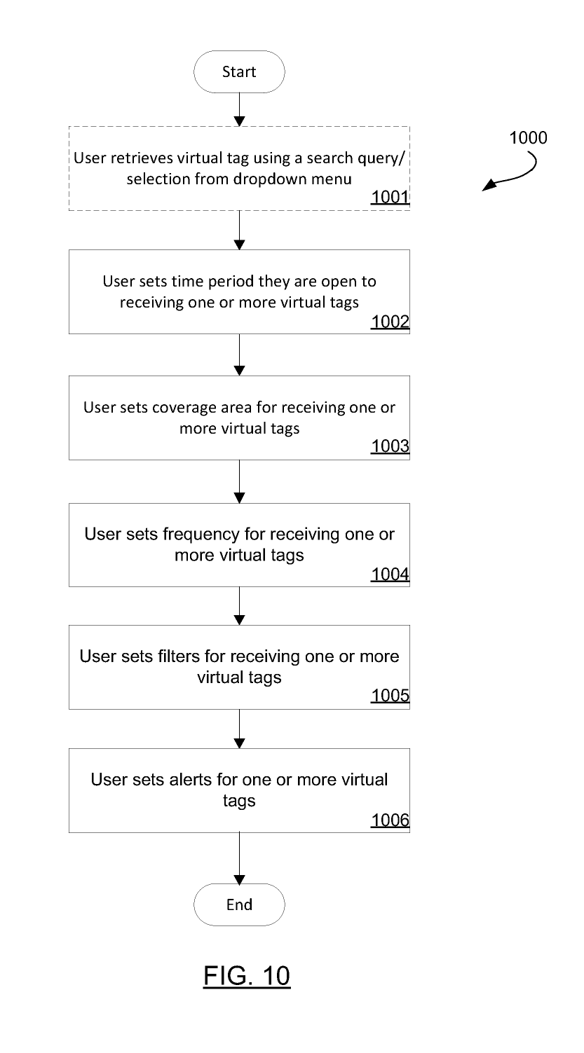

FIG. 10 illustrates a flow diagram showing one embodiment of setting user parameters for receiving virtual tags. A user, with communications device, who is interested in receiving geolocation virtual tags, sets their preferences for receiving geolocation virtual tags or alternately they set their preferences for a specific search string or a specific known tag or tag template. Using a virtual tag user interface (UI) provided on the user's communications device (e.g., smartphone), process 1000 begins with optional step 1001. In optional step 1001, the user obtains a known virtual tag or tag category or template by various methods such as inputting a search query or selecting an existing geolocation virtual tag from, for example a drop down menu. The search inputs may include images, text, audio or a combination thereof. The search query is sent to the search system (see FIG. 4) from the user's communication device (e.g., user searching device(s) 1011). Location information pertaining to the user's device present position is also sent to the search system to locate virtual tags in close proximity (e.g., within walking distance). The location information is provided to the network by a message sent from the user's communication device or other methods for communicating location information. In alternative embodiments, the location information is provided by a second mobile communication device. The search and location information are combined and transferred to the search system (FIG. 4) for processing.

Referring again to FIG. 10, step 1002 includes a user setting a time period that they are open to receiving one or more virtual tags. For example, a posting date range filter tool might be set to Jan. 1, 2012 through Mar. 1, 2012. Along with other search input and geolocation information, the search infrastructure would respond to a search request with only those virtual tags in proximity, matching the search input, and that were posted during the 2 months identified by the posting filter. Other types of filter tools might include virtual tag ratings, poster ratings, group member postings (social or ad hoc), posting content types, durations, etc. In step 1003, the user sets coverage, such as the distance for receiving one or more virtual tags. For example, I am only interested in virtual tags which are present within 100 ft of my communication device as I walk through the city, 1600 ft. when I am in a rural area and 3-5 miles when I am driving in the car (as determined by rate of change in position or other known or future methods). In step 1004, the user sets the frequency for receiving one or more virtual tags (e.g., hourly, daily, monthly, etc.). In step 1005, the user set additional filters for receiving one or more virtual tags (e.g., tags to avoid). Finally, in step 1005, the user sets alerts for receiving one or more virtual tags (e.g., sound, text, tactile, etc.).

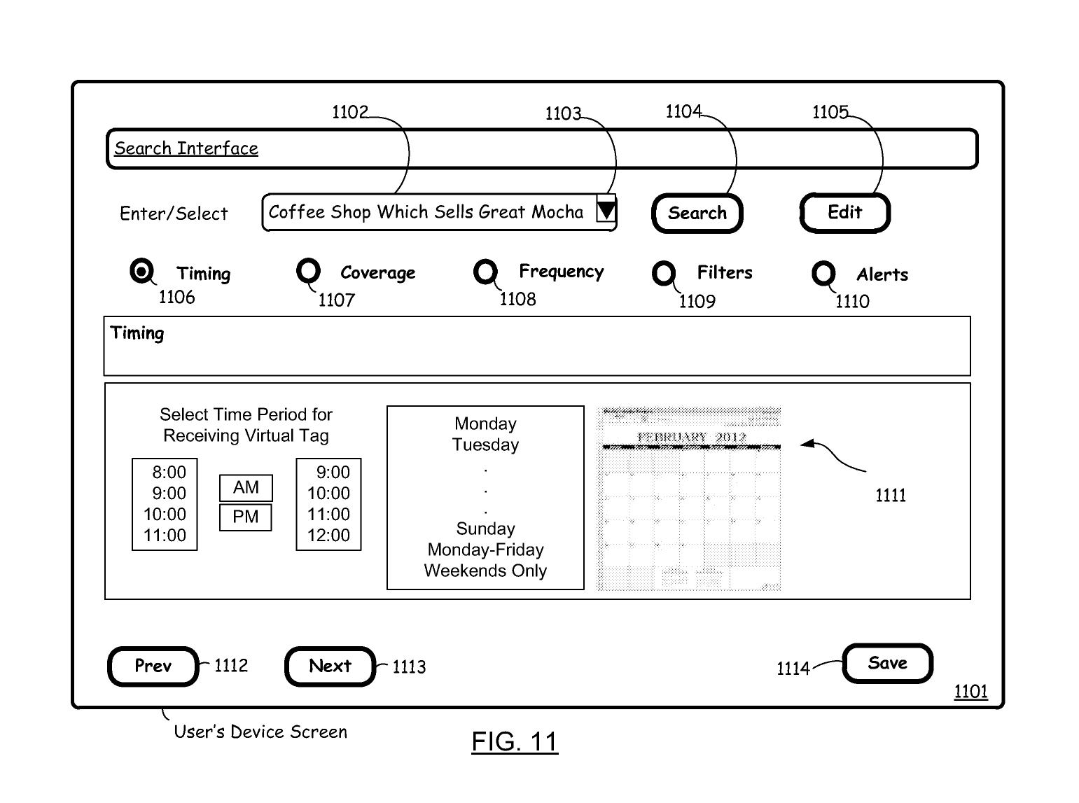

FIG. 11 illustrates one embodiment of a user interface (UI) to perform one or more of the method steps of FIG. 10. By illustrating a search interface on a user's device through which automated search behaviors are set up, they are managed and selectively/periodically launched behind the scenes by the user device or by a new node in the search service infrastructure. These behaviors, for example, involve preferences and filters relating to tag content. For example, a user might indicate a desire for coffee shop information every day between 6-8 AM, 11-2, 6-11 PM plus when within 200 meters when on foot, not Jo's Coffee Shop, not after having visited a coffee shop within the past hour, and with no repeat pinging (hysteresis) for a 24 hour period. That is, I should be able to define my own ranges beyond that defined by a poster (who may even have infinite range as I might have set as well). Virtual tags associated with a particular bank's ATM's, Chinese restaurants, etc., might be similarly configured and stored. These searches can then be applied upon drop down selection, automatically in background with alerts, or automatically when a browser/map is launched as tab entries.

Referring again to FIG. 11, search interface 1101 shown on a user's device screen (e.g., smartphone), includes fields 1102 for entering a search to locate geolocation virtual tags of interest, including, but not limited to: text; video; images; audio; code; etc. Selecting search 1104 or alternatively selecting 1103 a geolocation virtual tag from a drop down menu which can be edited 1105 initiates a search process. Search results are narrowed, in various embodiments, by selecting one or more user preferences to include, but not limited to: timing 1106; coverage 1107; frequency 1108; filters 1109; and alerts 1110. Preferences include user specific choices, standardized, default, or third party provided preferences (e.g., preferences from a study of effective preferences). As shown, timing preferences 1111 include specific times or time periods. For example, a user selects a specific time to view virtual tags (using only a first column time selection) or a time period by selecting from both a first and second time column. As is known, AM/PM is selected as desired. In addition to specified times, one may select specific days of the week, a typical work week (M-F), weekends only (Sat/Sun) as well as a selection from a calendar. It should be noted, that common or customized time related preferences are considered within the scope of the technology described herein, however, other time based preferences can be substituted without departing from the scope of the technology described herein. As previously discussed above, the various user preferences are set in various embodiments for generally receiving geolocation virtual tags (i.e., my preferences for any proximate geolocation virtual tag), attached to specific search strings, specific geolocation virtual tags or for geolocation virtual tags belonging to a specified set (e.g., want to receive coupons), or a specific template (e.g., menus). When completed a user saves their preferences 1114 and optionally moves to the previous or next user preferences screen.

In one embodiment, coverage preferences 1107 are included to narrow the geolocation virtual tag receiving area. For example, I am only interested in geolocation virtual tags which are in close proximity (the definition of close proximity may be variable from user-to-user based on their individual preferences). As shown, coverage is manually selectable, in various embodiments, by selecting a specific distance, typically radially, from the user. For example, show me only geolocation virtual tags from 1-100 ft away from me (based on detected position of my communications device). In an alternative embodiment, a coverage area or zone is chosen using conventional map area 902 selection techniques. It is envisioned that differing coverage preferences are equally within the scope of the technology described herein.

In one embodiment, frequency preferences 1108 allow a user to narrow their search and subsequent number of geolocation virtual tags received by only receiving geolocation virtual tags a specified number of times per some specified time frame. For example, I want to see geolocation virtual tags only twice per day. In alternative embodiments, a user may select from either standardized frequencies or from recommended or suggested ideal frequencies for a specified period. Without preference selection, a user in various embodiments would become overwhelmed with a never ending repetition of the same advertisement or a category of geolocation virtual tags. It is envisioned that differing frequency selections are equally within the scope of the technology described herein.

In one embodiment, filter preferences 1109 allow a user to narrow their search and subsequent number of geolocation virtual tags received. A user, in various embodiments avoids specific businesses (e.g., Jo's Coffee Shop), specific offers (e.g., no coffee offers if they don't drink coffee) or duplicate tags. It is envisioned that differing filters are equally within the scope of the technology described herein.

In one embodiment, alert preferences 1110 allow a user to select how they will be notified of geolocation virtual tags received. A user, in various embodiments will set alerts such as, but not limited to: voice (such a call or audio message); text (such as SMS text messaging); email; social media options (e.g., Facebook®, Tweets®, Instagrams®, etc.); and be able to select delivery methods, such as, but not limited to automatic, manual (on/off) and/or when browser map is opened. It is envisioned that differing alerts are equally within the scope of the technology described herein.

One embodiment implementation of geolocation virtual tags includes a mode activated by a walking user (with mobile communications device) in association with a particular and somewhat distant geolocation virtual tag posting location. This mode is used to draw in a roaming user to a posting location such as by: presentation of a series of geolocation virtual tag posting that each trigger at different distances from the posting geo-location; periodic alerts such as direction pop-ups (arrows, turning audio, “only 100 m away” type notifications); and determining drive/walk-byes and responding by delivering additional alerts such as supplemental directions or otherwise providing posting data attempting to draw the walker back on track.

In one aspect embodiment, the virtual tag has a potentially changing geolocation (mobile object) which is updated in the system as the object moves. For example, an owner of a car for sale can create a virtual tag with a picture of the car and additional information such as price, specs, contact info, etc. As the car is moved, potential customers in proximity to the moved vehicle would be notified that a car for sale is near them, possibly with a map and/or directions to its present location.

In one aspect embodiment, the virtual tag is in and of itself virtual (a virtual virtual tag). For example, a potential customer is on a website looking at a 3D image of the interior of a car. The website detects the potential customer's presence within one or more portions of the 3D image. Precreated virtual tags are brought to the potential customer's attention allowing a 3D virtual tag to be downloaded to their device which is displayed holographically or by holding the phone up to their eyes and moving it around in to scroll through various angles of provided 3D image.

While the figures include various screen shots such as posting and setting user preferences to provide various settings and selections, it is understood that the technology described herein is not limited by these specific construction techniques, settings or selections. Functionally equivalent, known and future, constructs, settings and constraints are interchangeable without departing from the scope of the technology described herein. For example, the posting and search interfaces, in various embodiments, share some or all of the same settings and selections or the aggregate of the two interfaces. In one exemplary embodiment, geolocation virtual tag construction uses web site creation tools simplified for quick composition. In other words, geolocation virtual tags piggy back on web creation tools using html/xml or functional equivalents, which inherently include files, access browser add-ons, etc., and are consumed by typical web browsers.

In an embodiment of the technology described herein the wireless connection can communicate in accordance with a wireless network protocol such as Wi-Fi, WiHD, NGMS, IEEE 802.11a, ac, b, g, n, or other 802.11 standard protocol, Bluetooth, Ultra-Wideband (UWB), WIMAX, or other known or future wireless network protocol, a wireless telephony data/voice protocol such as Global System for Mobile Communications (GSM), General Packet Radio Service (GPRS), Enhanced Data Rates for Global Evolution (EDGE), Personal Communication Services (PCS), or other known or future mobile wireless protocol or other wireless communication protocol, either standard or proprietary. Further, the wireless communication path can include separate transmit and receive paths that use separate carrier frequencies and/or separate frequency channels. Alternatively, a single frequency or frequency channel can be used to bi-directionally communicate data to and from the mobile communication device.

While the technology described herein is generally described using mobile communications devices, non-mobile devices such as PCs, devices which are not at the location to be tagged and other computing devices are within the scope of the technology described herein and in various embodiments create, receive, edit, store, and manage geolocation virtual tags.

Throughout the specification, drawings and claims various terminology is used to describe the various embodiments. As may be used herein, the terms “substantially” and “approximately” provides an industry-accepted tolerance for its corresponding term and/or relativity between items. Such an industry-accepted tolerance ranges from less than one percent to fifty percent. Such relativity between items ranges from a difference of a few percent to magnitude differences. As may also be used herein, the terms “geolocation virtual tags”, “geocoded virtual tags”, “virtual tags” and “tags” are considered equivalent. The terms “geo-code”, “geocode”, “geo-location” and “geolocation” are considered equivalent terms.

As may also be used herein, the terms “processing module”, “processing circuit”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The technology as described herein has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed technology described herein. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed technology described herein. One of average skill in the art will also recognize that the functional building blocks, and other illustrative blocks, modules and components herein, can be implemented as illustrated or by discrete components, application specific integrated circuits, processors executing appropriate software and the like or any combination thereof.

The technology as described herein may have also been described, at least in part, in terms of one or more embodiments. An embodiment of the technology as described herein is used herein to illustrate an aspect thereof, a feature thereof, a concept thereof, and/or an example thereof. A physical embodiment of an apparatus, an article of manufacture, a machine, and/or of a process that embodies the technology described herein may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While particular combinations of various functions and features of the technology as described herein have been expressly described herein, other combinations of these features and functions are likewise possible. The technology as described herein is not limited by the particular examples disclosed herein and expressly incorporates these other combinations.

1. A method creating annotated geolocations on a mobile communications device, the method comprising:
receiving an identified posting target to be annotated;
receiving an annotation associated with the identified posting target;
obtaining geolocation information of the identified posting target;
associating the identified posting target, the received annotation, and the provided geolocation to create a virtual tag; and
uploading to a search infrastructure at least the geolocation information and a pointer to the created virtual tag.

2. A method, as per claim 1, further comprising using the search infrastructure to provide one or more created virtual tags to one or more mobile display devices based on a current geolocation.

3. A method, as per claim 1, further comprising uploading and storing one or more portions of the created virtual tag in a virtual tag registry accessible by the search infrastructure.

4. A method, as per claim 1, further comprising authentication one or more of the tag creating steps.

5. A method, as per claim 1, wherein the created virtual tag comprises a mobile object.

6. A method, as per claim 5, further comprising uploading to the search infrastructure the received filter data associated with the created virtual tags.

7. A method, as per claim 1, further comprising supporting augmented reality systems by using the search infrastructure to provide one or more created virtual tags to one or more mobile display devices based on a current geolocation.

8. A method performed by a search service to support searching on a mobile communication device, the method comprising:
receiving a search query from the mobile communication device, the search query including at least geolocation information of the mobile communication device;
submitting the received search query to a search database comprising at least indexed content associated with the geolocation;
correlating the received search query with the indexed content to create one or more search results; and
forwarding the one or more of the search results to the mobile communication device for display.

9. A method, as per claim 8, further comprising the indexed content comprising mobile device posted content and the search results including a pointer to the mobile device posted content.

10. A method, as per claim 8, further comprising the search query including one or more of: text, video, image, audio and code.

11. A method, as per claim 8, further comprising the search results refined using search filters.

12. A method, as per claim 8, further comprising the search query stored by the mobile communications device and executed automatically according to periodicity producing new search results.

13. A method, as per claim 8, further comprising the periodicity comprising any of: time, location, distance from a specific location, or a combination of both.

14. A method, as per claim 8, further comprising supporting augmented reality systems by providing associated geocoded content to one or more mobile display devices.

15. A system to support searching of geocoded content, comprising:
a plurality of tags with associated geocoded content stored in memory;
a web crawler to access and index one or more of the plurality of tags with associated geocoded content stored in memory, the web crawler comprising:
a downloader to crawl and parse one or more of the plurality of tags with geocoded content;
a scheduler to schedule the downloader's crawling and parsing;
a link unit to provide pointers to the plurality of tags with associated geocoded content to the downloader; and
a download processor to index the crawled and parsed one or more of the plurality of tags with associated geocoded content to produce indexed data;
a database structure to store the indexed data; and
a search system to search the database structure and produce a search result.

16. A system, as per claim 15, wherein the search system returns one or more of the plurality of tags with associated geocoded content to a search requestor based on the search requestor device's current location.

17. A system, as per claim 15, further comprising the downloader preprocessing the associated geocoded content.

18. A system, as per claim 15, further comprising one or more user tagging devices providing the one or more of the plurality of tags with associated geocoded content stored in memory.

19. A system, as per claim 15, wherein the plurality of tags with associated geocoded content are stored in memory located in any of: locally on the one or more user tagging devices; remotely from the one or more user tagging devices, in cloud-based servers or a combination thereof.

20. A system, as per claim 15, further comprising search filters including one or more of, a combination of, or a range of: posting date(s); rating(s); time; content type(s); poster(s); social contact(s); and popularity.
